(19) United States
(12) Patent Application Publication
(10) Pub. No.: US 2004/0104307 A1
(43) Pub. Date: Jun. 3, 2004

(54) Escape chute

(76) Inventor: Peter David Stokes, North Elmham (GB)

Correspondence Address: Monique A Moreault, Wallenstein & Wagner, 53rd Floor, 311 South Wacker Drive, Chicago, IL, 60606, US

(21) Appl. No.: 10/472,725

(22) PCT Filed: Mar. 18, 2002
(86) PCT No.: PCT/GB02/01263

(30) Foreign Application Priority Data
Mar. 17, 2001 (GB) 0106714.9

(51) Int. Cl. B64D 25/14

(52) U.S. Cl. 244/137.2; 182/48; 244/905; 193/25 B

(57) ABSTRACT

An escape chute (11) for an aircraft, the chute (11) having a collapsed condition for storage of the chute in an confined or reduced space and an extended condition providing a ramp down which people can slide, and means (15,16) for illuminating the chute in the extended condition, characterised in that the illumination means (15,16) is activated when the chute (11) is deployed to provide illumination identifying the position of the chute without relying on an electrical power source.

This invention relates to escape chutes and in particular, but not exclusively, to escape chutes for use in aircraft to assist evacuation of passengers and aircrew in an emergency.

Aircraft, especially passenger aircraft, typically have a door at the front of the passenger cabin and often a door at the rear of the passenger cabin in larger aircrafts by means of which passengers and aircrew can get on and off the aircraft.

These doors are too high for a person to get on and off the aircraft without assistance. For example, on a Boeing 747 the doors may be 16 feet above the ground. Accordingly the aircraft are normally brought to an area near the terminus away from the runways where people can get on and off either using a mobile stairway positioned alongside the aircraft or by a retractable tunnel providing a covered walkway between the terminus and the aircraft.

In an emergency, for example during take-off or landing, the aircraft will often come to a stop on the runway well away from the terminus. In this situation, escape chutes are provided that can be deployed to provide a ramp down which people can slide from the doors to the ground. Such escape chutes provide a simple method of allowing people to get down to the ground quickly and safely.

Existing escape chutes are normally stored in a collapsed condition and are deployed when a release mechanism is actuated to connect the chute to a supply of an inert gas such as nitrogen to inflate the chute and reduce the risk of fire and explosion if any fuel has escaped.

In an emergency, some people may hesitate before using the chute, especially if it is necessary to evacuate the aircraft in darkness. Any delay not only increases the time to evacuate the aircraft but also creates a hazard which may result in the door being blocked if people behind are pushing in the panic to evacuate the aircraft. Thus, it is important to ensure a smooth, continuous movement of people to the door and onto the chute in an orderly manner to provide efficient evacuation of the aircraft in the shortest possible time.

It is know to provide means for illuminating the chute so that passengers can clearly see where the chute is and get onto it with confidence. Currently, such illumination is provided by an electrically powered light source such as an external spotlight mounted on the body of the aircraft or by a plurality of miniature incandescent bulbs extending the length of the chute, usually on opposite sides to identify a path between the edges of the chute down which passengers should slide.

Both of these methods of illumination require an electrical power supply to energise the spotlight or the bulbs. Usually, such power supply is provided by storage batteries. In an emergency, the power supply may fail, for example if there is damage to the batteries and/or to the electrical wiring connecting the batteries to the light source. Such damage may occur if there is damage to the structure of the aircraft or if a fire breaks out. As a result, such electrically powered means of illumination may be rendered inoperative at the very time it is required.

Moreover, where an external spotlight is provided, this may be broken off or its orientation altered so that, if still operable, it no longer illuminates the chute. Also, the chute may inflate in such a way that it is not illuminated by an external spotlight.

Furthermore, where miniature incandescent bulbs are incorporated into the structure of the chute, these may be damaged or broken either when the chute is folded into its collapsed, inoperative condition for storage or when the chute is rapidly inflated on being deployed.

As a result the existing systems for illuminating the chute are unreliable and may be inoperable or fail at the time they are required following an emergency during take-off or landing.

The present invention has been made from a consideration of the foregoing problems and disadvantages of existing escape chutes.

More particularly, the present invention seeks to provide an escape chute which mitigates one or more of the problems or disadvantages of the existing escape chutes.

Thus, it is an preferred object of the present invention to provide an escape chute with means operable to illuminate the chute when deployed that does not rely on an electrical power supply.

It is a further preferred object of the present invention to provide an escape chute wherein the illumination means is operable automatically when the chute is deployed.

It is yet another preferred object of the present invention to provide an escape chute wherein the illumination means provides a light source for a period of time sufficient to allow evacuation of the aircraft.

It is a still further preferred object of the present invention to provide an escape chute wherein the illumination means is operable in a safe, reliable manner without creating a risk or hazard to the integrity of the chute or the passengers using the chute.

It is yet another preferred object of the present invention to provide an escape chute wherein the illumination means is of simple construction capable of being incorporated into the structure of the escape chute without adverse effect on the deployment and use of the chute.

Thus, according to a first aspect of the invention there is provided an escape chute for an aircraft, the chute having a collapsed condition for storage of the chute in a confined or reduced space and an extended condition providing a ramp down which people can slide, and means for illuminating the chute in the extended condition, characterised in that the illumination means is activated when the chute is deployed to provide illumination identifying the position of the chute without relying on an electrical power source.

By this invention, the chute is illuminated on being deployed to provide an indication of its position independently of connection to an electrical power source such as storage batteries. As a result, illumination is not compromised by failure of the power supply or by damage to the light source.

Preferably the illumination means is chemiluminescent. That is to say a chemical reaction between two or more reactants is activated when the chute is deployed which generates a source of light that decays gradually with time to provide light for a sufficient period of time to allow evacuation of the aircraft.

Advantageously, the reactants are stored separately and the chemical reaction is initiated by allowing the reactants to come together when the chute is deployed. For example, the gas pressure to inflate the chute may cause a membrane separating the reactants to rupture as the chute is deployed and unfolds from its collapsed, inoperative condition to its extended operative condition.

Preferably, the illumination means is provided at both sides of the chute so as to provide an indication of the lateral edges of the chute between which the passengers can slide down safely to the ground when the chute is deployed.

The illumination means may emit light substantially continuously along the length of the chute or it may emit light at a series of positions spaced apart along the length of the chute. For example, the illumination means may comprise a sealed capsule extending the length of the chute in which the reactants are stored for mixing when the chute is deployed. Alternatively, the illumination means may comprise a plurality of capsules spaced apart along the length of the chute in which the reactants are stored for mixing when the chute is deployed.

Preferably, the or each capsule is made of transparent or translucent material, typically plastics, that is inert to the reactants both when stored separately and when mixed together to produce the light source. The or each capsule may be adapted to emit light having a particular colour.

Advantageously, the membrane separating the chemicals is self-rupturing when the chute is deployed. For example, as the chute is inflated from its collapsed, inoperative condition to its extended, operative condition, the inflation forces may cause the membrane to rupture. Alternatively, a member may be provided to puncture the membrane when the chute is deployed. For example, a spike that is normally spaced from the membrane in the deflated, inoperative condition of the chute and that pierces the membrane as the chute is inflated.

According to a second aspect of the invention there is provided a method of illuminating an escape chute by initiating a chemical reaction to produce a light source chemiluminescently when the chute is deployed.

Any chemicals that react to emit light chemiluminescently may be employed. Preferred chemicals are those which can be stored without degrading for a long period of time and which, on mixing emit visible light for at least five minutes, more preferably at least ten minutes and more preferably still at least thirty minutes. Suitable reactants include those available under the trade name “Cyalume” from Omniglow, USA and “Kalume” from Kai Gee, Taiwan.

According to a third aspect of the invention there is provided an aircraft provided with an escape chute according to the first aspect of the invention.

Other features, benefits and advantages of the invention will be apparent from the following description of exemplary embodiments with reference to the accompanying drawings wherein:—

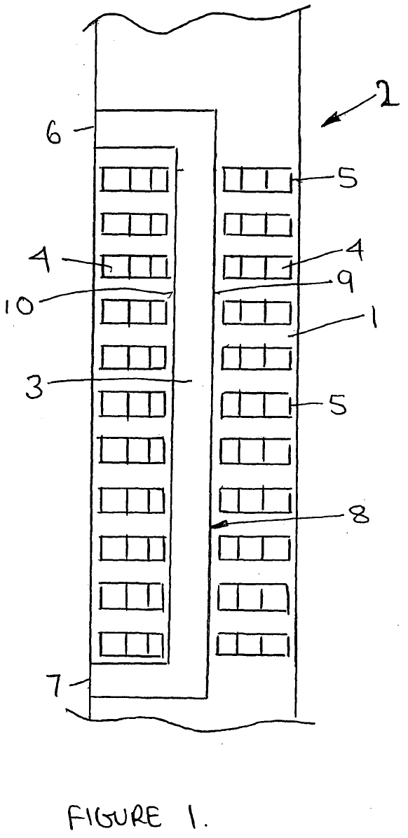

FIG. 1 is a schematic plan view of the lay-out of the interior of a passenger cabin of an aircraft;

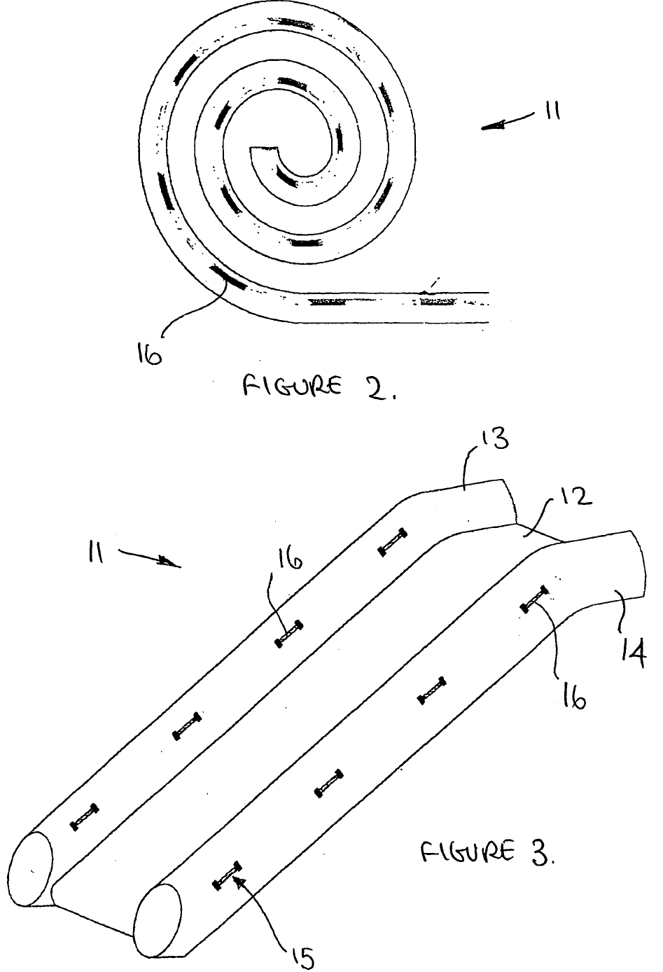

FIG. 2 is a schematic side view of an escape chute embodying the invention in a deflated, stored condition;

FIG. 3 is a schematic perspective view of the escape chute of FIG. 1 in an inflated, operative condition;

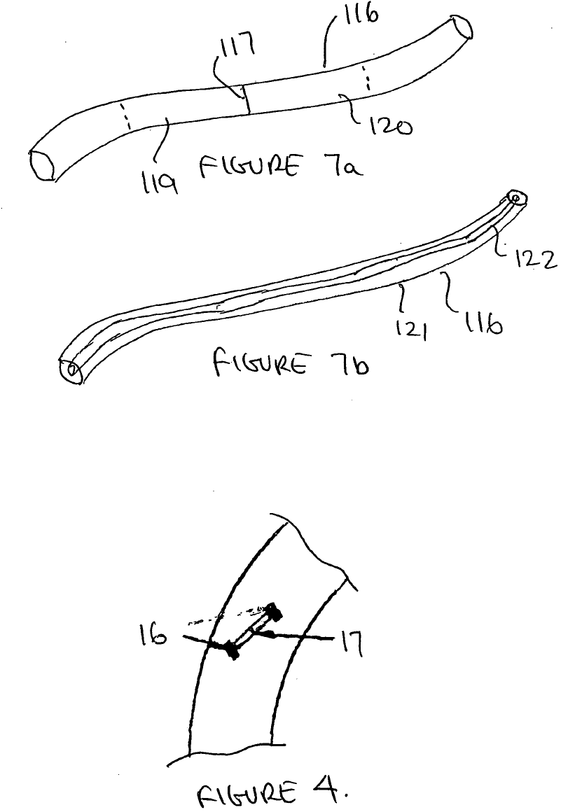

FIG. 4 is a detailed view of part of the escape chute in the deflated stored condition.

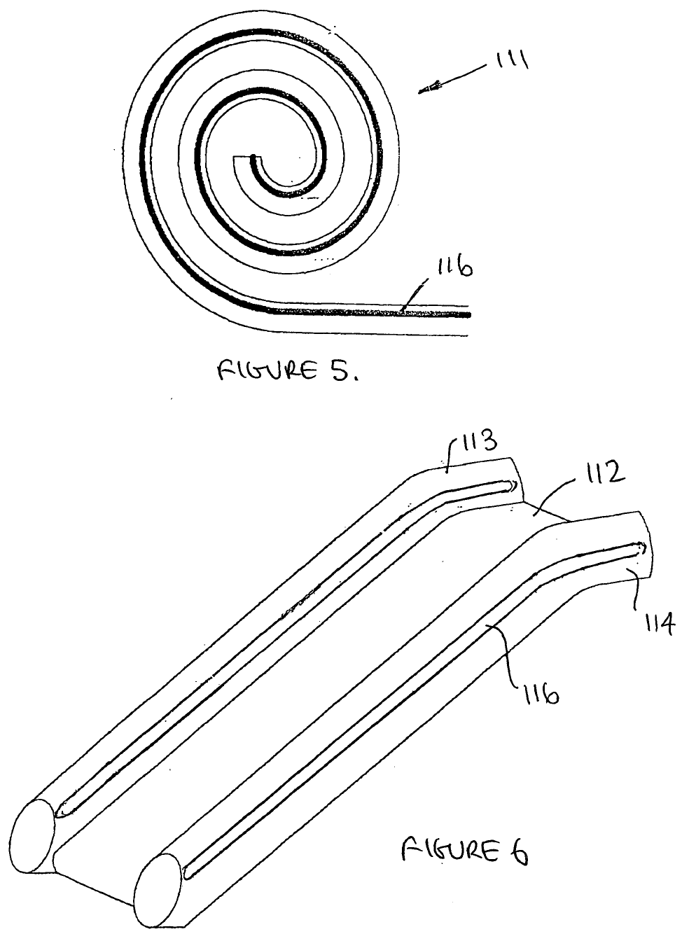

FIG. 5 is a schematic side view of an alternative escape chute embodying the invention in a deflated, stored condition;

FIG. 6 is a schematic perspective view of the chute shown in FIG. 5 in an inflated operative condition; and

FIGS. 7a, 7b show alternative constructions of capsule for the chute shown in FIGS. 5 and 6.

Referring first to FIG. 1, of the drawings, there is shown the interior of a passenger cabin 1 of an aircraft 2. A central aisle 3 extends longitudinally of the cabin 1 with seats 4 arranged in rows 5 on either side of the aisle 3. In this embodiment, three seats are arranged on each side of the aisle 3 in each row 5 but it will be understood the number and arrangement of seats 4 and rows 5 may be altered from that shown.

The aircraft 2 is provided with doors 6, 7 at the front and rear ends of the passenger cabin 1 for passengers to get on and off the aircraft 2. In addition, the aircraft 2 may be provided with exit doors (not shown) on either side of the passenger cabin 1 usually over the wings (not shown) for use in an emergency only.

In normal conditions, access to and from the aircraft 2 via the doors 6, 7 is effected by positioning a mobile stairway (not shown) alongside the aircraft 2 or by extending a telescopic tunnel (not shown) to provide a covered walkway between the aircraft and terminal building (not shown).

As shown, the aircraft 2 is provided with an emergency lighting system 8 in the form of a pair of guide tracks 9, 10 arranged on opposite sides of the aisle 3 and extending longitudinally of the aisle 3.

The tracks 9, 10 provide light sources (not shown) in an emergency to define the sides of the aisle and identify an escape route for passengers to follow from any row 5 of seats 4 along the aisle 3 to the doors 6, 7 at the front and rear ends of the aircraft 2.

The tracks 9,10 may be electrically powered, for example a series of longitudinally spaced apart incandescent light bulbs or strips of electroluminescent material connected to a power source such as, storage batteries.

Alternatively, the tracks may be photoluminescent so as to be operable independently of any power source. A suitable photoluminescent lighting system is described in our UK Patent No. 2314536 the contents of which are incorporated herein by reference.

In an emergency or other situation requiring rapid evacuation of the aircraft without the normal means of access to and from the aircraft described previously, the height of the doors 6, 7 above the ground is such that, there would be a serious risk of personal injury if people attempted to exit the aircraft 2 by jumping to the ground from the doors 6, 7.

Accordingly with reference now also to FIGS. 2, 3 and 4, an inflatable escape chute 11 is installed at each of the doors 6, 7 for use in an emergency to enable passengers to evacuate the aircraft 2 safely. Where emergency exits are provided over the wings, an escape chute is not normally provided.

Each chute 11 is similar and comprises a centre portion 12 and side portions 13, 14. The portions 12, 13, 14 are hollow and, when inflated, provide an elongate inclined ramp extending from the door 6, 7 to the ground down which passengers can slide to evacuate the aircraft 2.

The centre portion 12 provides a flat surface for passengers to slide down and the side portions 13, 14 provide walls to prevent passengers sliding off the centre portion 12 between the ends of the chute 11. In this way, passengers are guided safely down to the ground and can get up and move away from the vicinity of the aircraft 2.

The chute 11 is made of flexible plastic material which, in the deflated condition, can be rolled up as shown in FIG. 2 into a compact form of generally cylindrical shape for storage in a compartment (not shown) until required.

The chute 11 is connected to a supply of an inert gas such as nitrogen in a cylinder (not shown) and is activated in an emergency by any suitable means such as a release lever or handle (not shown) to inflate automatically to the extended, operative condition shown in FIG. 3.

The release lever or handle may also open the door 6, 7 in an emergency so that the chute 11 is deployed when the door 6, 7 is opened with the emergency lever or handle. Such emergency door operating mechanism is separate from the mechanism for opening the door in normal conditions.

Alternatively, the release lever or handle for the chute may be separate from the door release mechanism and require operation independently thereof to deploy the chute 11. In this arrangement. The door operating mechanism may open the door in both normal and emergency conditions.

In an emergency, it is important to evacuate the aircraft as quickly as possible and some passengers may be reluctant to use the chute 11, especially in conditions of darkness or low illumination if they cannot see the position of the chute 11.

In accordance with the present invention, the chute 11 includes chemiluminescent means 15 operable when the chute 11 is deployed to provide illumination along the length of the chute 11. In this way, the position of the chute 11 can be easily seen allowing passengers to move onto and use the chute 11 with confidence.

The chemiluminescent means 15 comprises a plurality of capsules 16 longitudinally spaced apart in each of the side portions 13, 14. The capsules 16 contain reactants separated by a membrane 17 which is ruptured when the chute 11 is deployed to allow the reactants to mix and produce a light source.

In this way, the side portions 13, 14 are illuminated at spaced intervals along the length of the chute 11 and identify the lateral edges of the chute 11 between which the passengers are to slide to the ground.

By positioning the illumination means 15 in the side portions 13, 14 the light emitted by the capsules 16 is not blocked by the presence of people on the centre section 12 in use of the chute 11. As a result, the position of the chute 11 remains visible during use and following passengers can take their turn with confidence thereby reducing the risk of delays.

Each capsule 16 is constructed and arranged so that integrity of the membrane 17 is maintained when the chute 11 is rolled up for storage in its deflated condition so as to keep the reactants apart. On being deployed, the chute 11 is rapidly inflated and the forces generated as the chute 11 unrolls causes the membranes 17 to rupture allowing the reactants to mix producing a chemical reaction that generates a light source by chemiluminescence. Examples of suitable reactants that may be used for this purpose, include those available under the trade name “Cyalume” from Omniglow, USA and “Kalume” from Kai Gee, Taiwan.

The capsules 16 are made of transparent or translucent plastics that allow the light emitted by the chemical reaction to be seen. The plastics may be chosen to modify the colour of the light for enhanced visibility, especially in conditions of low illumination and/or in the presence of smoke, for example, the capsules 16 may emit a yellow light when activated.

Referring now to FIGS. 5 and 6, an alternative embodiment is shown in which like reference numerals in the series 100 are used to indicate corresponding parts.

In this embodiment, a single capsule 116 is provided extending longitudinally of each side portion 113, 114. The capsule 116 contains the reactants separated by a flexible membrane 117 which ruptures when the chute 111 is deployed to allow the reactants to mix and produce a light source by chemiluminescence. In this way, the light source is continuous along the length of the chute 111.

The capsule 116 is made of a flexible transparent or translucent plastics which can be rolled up without rupturing the membrane 117 when the chute 111 is deflated and rolled up to its collapsed, inoperative position for storage. The inflation forces cause the membrane 117 to rupture to mix the reactants when the chute 111 is deployed and the plastics of the capsule 116 may be chosen to modify the colour of the light emitted as described in the previous embodiment.

Referring now to FIG. 7a, one construction of capsule 116 is shown comprising an elongate tube 118 divided by the membrane 117 into compartments or zones 119, 120 for storing the reactants separately from each other until the membrane 117 is ruptured.

The tube 118 may have several membranes 117 spaced apart longitudinally to provide many compartments or zones for storing the reactants to promote rapid mixing when the chute 111 is deployed.

FIG. 7b shows another construction of capsule 116 comprising an elongate outer tube 121 and an elongate inner tube 122. One of the reactants fills the inner tube 122 and the other reactant surrounds the inner tube 122 within the outer tube 121. In this construction, the inner tube 122 forms the membrane separating the reactants and is ruptured when the chute 111 is deployed to mix the reactants.

As will be understood, the present invention provides an escape chute 11, 111 having means for illuminating the chute 11, 111 which is operable automatically when the chute 11, 111 is deployed and which does not rely on any electrical power source to provide the illumination. Thus the light source is generated chemiluminescently by mixing reactants that are stored separately and brought together when the chute 11, 111 is deployed to emit light by the chemical reaction therebetween. In this way, illumination of the chute 11, 111 is ensured in an effective, reliable manner that eliminates the problems and disadvantages of the existing electrically powered illumination means currently employed.

Although the invention has been described with reference to what are currently the best methods known to the applicant for putting the invention into practice, it will be understood that improvements and modifications can be made within the spirit and scope of the invention as described.

For example, the illumination means may be provided in both side portions of the chute as described or in one side portion only. Alternatively or additionally to location of the illumination means in the side portions, the illumination means may be provided in the centre portion.

Any suitable means may be employed for storing the reactants in the collapsed condition of the chute and for bringing the reactants together when the chute is deployed to generate a light source automatically. For example, the chemical reaction for generating the required illumination of the inflated chute may be initiated by rupturing a membrane when the chute is activated to allow the reactants to mix as described. Alternatively, a valve may be used that is responsive to activation of the chute to allow the reactants to mix. The valve may be operated by the inflation pressure or by the release mechanism for the chute.

The reactants may be stored separately along the deflated chute as described. Alternatively the reactants may be stored separately at a pre-determined location and delivered along the chute when it is activated. Thus, activation of the chute may rupture a membrane or operate a valve to allow the reactants to mix and flow down from the top of the chute in a controlled manner as the chute inflates. The reactants may be stored separately from the chute and supplied to a conduit extending the length of the chute when it is activated.

Other modifications will be apparent to those skilled in the art and the invention is intended to include all possible variations within the scope of the invention as described herein.

1. An escape chute (11;111) for an aircraft, the chute (11;111) having a collapsed condition for storage of the chute in a confined or reduced space and an extended condition providing a ramp down which people can slide, and means (15,16;116) for illuminating the chute in the extended condition, characterised in that the illumination means (15,16;116) is activated when the chute is deployed to provide illumination identifying the position of the chute without relying on an electrical power source.

2. An escape chute according to claim 1, wherein the illumination means is chemiluminescent (16;116).

3. An escape chute according to claim 2, wherein a chemical reaction between two or more reactants is activated when the chute is deployed which generates a chemiluminescent source of light that decays gradually with time to provide light for a sufficient period of time to allow evacuation of the aircraft.

4. An escape chute according to claim 3, wherein the reactants are stored separately and the chemical reaction is initiated by allowing the reactants to come together when the chute is deployed.

5. An escape chute according to claim 4, wherein gas pressure to inflate the chute causes a membrane (17;117) separating the reactants to rupture as the chute is deployed and unfolds from its collapsed, inoperative condition to its extended operative condition.

6. An escape chute according to any one of the preceding claims, wherein the illumination means (15,16:116) is provided at both sides (13,14) of the chute so as to provide an indication of the lateral edges of the chute between which the passengers can slide down safely to the ground when the chute is deployed.

7. An escape chute according to any one of the preceding claims, wherein the illumination means emits light substantially continuously along the length of the chute.

8. An escape chute according to claim 7, wherein the illumination means comprises a sealed capsule (116) extending the length of the chute in which the reactants are stored for mixing when the chute is deployed.

9. An escape chute according to any one of claims 1 to 6, wherein the illumination means (16) emits light at a series of positions spaced apart along the length of the chute.

10. An escape chute according to claim 9, wherein the illumination means comprises a plurality of capsules (16) spaced apart along the length of the chute in which the reactants are stored for mixing when the chute is deployed.

11. An escape chute according to claim 8 or claim 10, wherein the or each capsule is made of transparent or translucent material that is inert to the reactants both when stored separately and when mixed together to produce the light source.

12. An escape chute according to claim 8 or claim 10, wherein the or each capsule is adapted to emit light having a particular colour.

13. An escape chute according to claim 5, wherein the membrane (17;117) separating the chemicals is self-rupturing when the chute is deployed.

14. An escape chute according to claim 13, wherein as the chute is inflated from its collapsed, inoperative condition to its extended, operative condition, the inflation forces cause the membrane (17;117) to rupture.

15. An escape chute according to claim 13, wherein a member is provided to puncture the membrane (17;117) when the chute is deployed.

16. An escape chute according to claim 15, wherein the puncturing member comprises a spike that is normally spaced from the membrane in the deflated, inoperative condition of the chute and pierces the membrane as the chute is inflated.

17. An escape chute according to claim 3, wherein the chemical reactants are stored within the chute in the inoperative, collapsed condition.

18. An escape chute according to claim 3, wherein the chemical reactants are stored separately from the chute in the inoperative, collapsed condition and supplied to the chute in response to the chute being deployed.

19. An escape chute according to any one of the preceding claims, wherein the chute comprises a hollow body connectable to a source of inert gas for inflating the body when the chute is deployed.

20. An escape chute according to any one of the preceding claims, wherein the chute can be rolled up into a compact cylindrical form for storage in the inoperative, collapsed condition.

21. A method of illuminating an escape chute (11;111) by initiating a chemical reaction to produce a light source (15,16;116) chemiluminescently when the chute is deployed.

22. A method according to claim 21, wherein the light source (15,16;116) emits light chemiluminescently for at least five minutes.

23. A method according to claim 21, wherein the light source emits light chemiluminescently for at least ten minutes.

24. A method according to claim 21, wherein the light source emits light chemiluminescently for at least thirty minutes.

25. A method according to any one of claims 21 to 24, wherein the chemical reaction is initiated by mixing two reactants when the chute is deployed.

26. A method according to claim 25, wherein the reactants are stored separately within the chute in an inoperative, collapsed and stored condition of the chute.

27. A method according to claim 25, wherein the reactants are stored separately in an inoperative, collapsed and stored condition of the chute and delivered to the chute when the chute is deployed.

28. A method according to any one of claims 21 to 27, wherein the light source is provided along one or both side edges (13,14) of the chute.

29. An aircraft provided with an escape chute according to any one of claims 1 to 20.

30. An aircraft according to claim 29, wherein the escape chute (11;111) is stored in the inoperative, collapsed condition at an exit from the aircraft and is connected to a source of inert gas for inflating the chute in response to actuation of a release mechanism.

31. An aircraft according to claim 30, wherein the chute is deployed in response to actuation of the release mechanism to open the exit.
